(19) United States
(12) Patent Application Publication
(10) Pub. No.: US 2009/0052276 A1
(43) Pub. Date: Feb. 26, 2009

(54) Agitator

(76) Inventor: Edward J. Grieb, Liverpool, NY (US)

Correspondence Address: PASTEL LAW FIRM;CHRISTOPHER R. PASTEL, 8 PERRY LANE, ITHACA, NY, 14850-9267, US

(21) Appl. No.: 11/845,050

(22) Filed: Aug. 25, 2007

(51) Int. Cl. B01F 13/00; B28B 5/00; B29C 69/00

(52) U.S. Cl. 366/343; 264/241; 264/250

(57) ABSTRACT

An agitator head tailored for mixing a viscous liquid such as driveway sealer or paint has an elongated shape consisting of two arcs which meet at their end points, and a common chord between the two arcs passes through a center of the head. Each arc is radiused to match the radius of a container holding the liquid to be mixed. A plurality of tapered openings in the head permit easy vertical movement through the liquid in the container. Vertical ribs in the head provide the structural strength necessary to withstand the force of agitation and keep the head from breaking.

### FIELD OF THE INVENTION

This invention relates generally to the field of agitators, and more particularly to an agitator designed for mixing a viscous liquid.

### BACKGROUND OF THE INVENTION

In sealing asphalt pavements, such as driveways and parking lots, it is common practice to apply a liquid sealant material to the asphalt surface, uniformly spread the sealant onto the surface with a brush, and then squeegee the material to provide a uniform coating and ensure that any cracks are filled. The most time consuming part of the process is thoroughly mixing the liquid sealer before use. Everyone who has tried to mix driveway sealer finds it to be an incredibly frustrating chore, because the usual techniques of hand mixing using a stirring rod or power mixing using a drill with a special bit are extremely tedious and slow.

### SUMMARY OF THE INVENTION

Briefly stated, an agitator head tailored for mixing a viscous liquid such as driveway sealer or paint has an elongated shape consisting of two arcs which meet at their end points, and a common chord between the two arcs passes through a center of the head. Each arc is radiused to match the radius of a container holding the liquid to be mixed. A plurality of tapered openings in the head permit easy vertical movement through the liquid in the container. Vertical ribs in the head provide the structural strength necessary to withstand the force of agitation and keep the head from breaking.

According to an embodiment of the invention, an agitator for mixing a liquid in a cylindrical container includes a head, wherein the head includes two circumferential ribs having an arcuate shape, the circumferential ribs meeting at their end points, wherein a common chord between the two circumferential ribs passes through a center of the head; each circumferential rib being radiused to match a radius of the container; a cylindrical central hub; a plurality of radial ribs connecting the central hub to the circumferential ribs; and a plurality of tapered openings in the head disposed between at least two of the radial ribs.

According to an embodiment of the invention, a method of manufacturing an agitator to mix a liquid in a cylindrical container includes the steps of: (a) forming a one-piece head which includes two circumferential ribs having an arcuate shape, the circumferential ribs meeting at their end points, wherein a common chord between the two circumferential ribs passes through a center of the head, wherein each circumferential rib is radiused to match a radius of the container; (b) forming a cylindrical central hub; (c) forming a plurality of radial ribs connecting the central hub to the circumferential ribs; and (d) forming a plurality of tapered openings in the head disposed between at least two of the radial ribs.

### BRIEF DESCRIPTION OF THE DRAWINGS

FIG. 1 shows a perspective view of an embodiment of the present invention.

FIG. 2 shows a front elevation view of the embodiment of FIG. 1.

FIG. 3 shows a top plan view of the embodiment of FIG. 1.

FIG. 4 shows a side elevation view of the embodiment of FIG. 1.

FIG. 5 shows a bottom plan view of the embodiment of FIG. 1.

### DETAILED DESCRIPTION OF THE PREFERRED EMBODIMENT

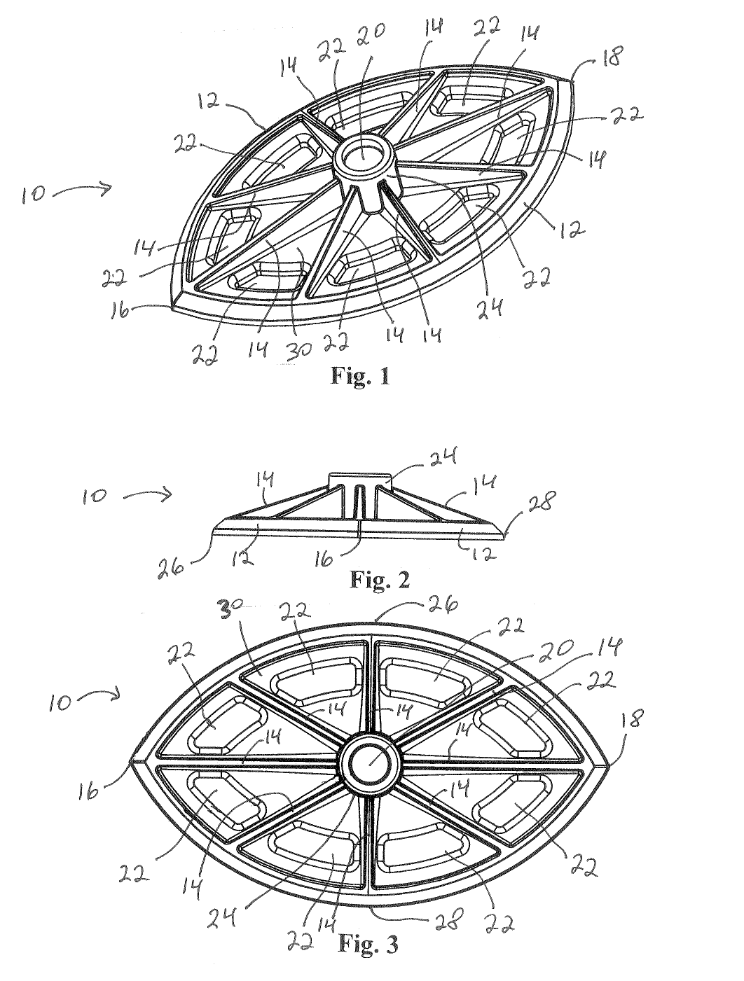

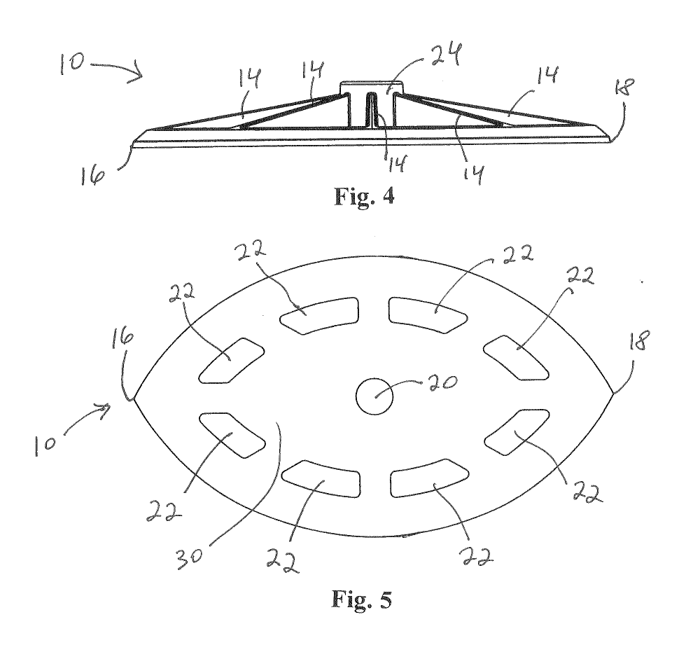

Referring to FIGS. 1-5, an agitator head 10 includes two circumferential ribs 12 and a plurality of vertical radial ribs 14. Circumferential ribs provide exterior strength to head 10, while radial ribs 14 are structural ribs. Circumferential ribs 12 are arcuate in shape, with each rib 12 radiused to match a radius of a container holding a viscous liquid to be mixed. Ribs 12 are preferably chamfered on an upper side to aid in cleaning the interior walls of the container. Ribs 12 meet at their end points 16, 18. A common chord between end points 16, 18 passes through a center of a central hole 20 in head 10. Central hole 20 is preferably threaded with a ¾″ female course thread to permit attaching a broom handle or paint roller extension handle to head 10.

Head 10 includes a flat portion 30 which is divided by radial ribs 14 into separate sections. Each section preferably contains a tapered opening 22 which permits easy vertical movement through the liquid in the container during mixing. Radial ribs 14 in head 10 provide the structural strength necessary to keep head 10 from breaking during use. A total of eight vertical radial ribs are preferable, although six or four ribs would work depending on the structural strength of head 10. Each radial rib 14 runs between one circumferential rib 12 and a center hub 24. Each pair of radial ribs 14 preferably has one opening 22 between them, although fewer openings 22 are possible. Openings 22 can be any shape, but preferably are generally oblong or four-sided, with sides 22a and 22c matching the curve of circumferential ribs 12 and sides 22b and 22d being parallel to the ribs 14 adjacent to the particular opening 22. Openings 22 are preferably symmetrical in shape.

Head 10 is preferably one-piece and made of injection molded plastic or cast metal, with a nominal wall thickness in flat portion 30 preferably of 0.25 inches and a nominal rib thickness preferably of 0.18 inches. Head 10 is preferably made using injection mold structural foam, preferably polypropylene, although other plastics or cast metals could be used. A height of center rib 24 is preferably 1.25 inches, with the preferred optional threading in central hole 20 being 0.75 inch coarse thread (female). End points 16, 18 are preferably 8.97 inches apart, with a distance between points 26 and 28 preferably being 5.50 inches apart. These head 10 dimensions are preferably for a five-gallon bucket, and would be modified to fit a one-gallon bucket or other diameter buckets.

Head 10 is designed to mix viscous liquids such as driveway sealer, paint, roof coating materials, or any product that comes in a five-gallon or one-gallon bucket. If head 10 is made of stainless steal, head 10 could be used in the food service industry. The product is mixed quickly, thoroughly, and easily with little effort or time, without creating a mess.

Head 10 works when moved in an up and down (vertical) motion within the bucket, loosening settled solids on the bottom of the bucket first, and then slowly integrating looser liquids on the top as the product in the bucket is mixed.

While the present invention has been described with reference to a particular preferred embodiment and the accompanying drawings, it will be understood by those skilled in the art that the invention is not limited to the preferred embodiment and that various modifications and the like could be made thereto without departing from the scope of the invention as defined in the following claims.

What is claimed is:

1. An agitator for mixing a liquid in a cylindrical container, comprising:
a head, wherein the head comprises
two circumferential ribs having an arcuate shape, the circumferential ribs meeting at their end points, wherein a common chord between the two circumferential ribs passes through a center of the head;
each circumferential rib being radiused to match a radius of the container;
a cylindrical central hub;
a plurality of radial ribs connecting the central hub to the circumferential ribs; and
a plurality of openings in the head disposed between at least two of the radial ribs.

2. An agitator according to claim 1, further comprising a handle affixed to the central hub of the head.

3. An agitator according to claim 2, wherein the central hub includes an opening therein, an inside of the opening is threaded, and the handle includes a threaded end affixed to the central hub via the opening.

4. An agitator according to claim 1, wherein the head is one-piece and is made of polypropylene structural foam.

5. An agitator according to claim 1, wherein the plurality of openings have four sides, wherein a first side and a third side are radiused to match the radius of the container, and the second and fourth sides are parallel to a respective adjacent radial rib.

6. An agitator according to claim 1, wherein the plurality of openings are tapered.

7. A method of manufacturing an agitator to mix a liquid in a cylindrical container, comprising the steps of:
forming a one-piece head which includes two circumferential ribs having an arcuate shape, the circumferential ribs meeting at their end points, wherein a common chord between the two circumferential ribs passes through a center of the head, wherein each circumferential rib is radiused to match a radius of the container;
forming a cylindrical central hub;
forming a plurality of radial ribs connecting the central hubs to the circumferential ribs; and
forming a plurality of openings in the head disposed between at least two of the radial ribs.

8. A method according to claim 7, wherein the steps of forming are done via injection molding and wherein the head is made of a molded thermoplastic material.

9. A method according to claim 8, wherein the head is made of structural foam polypropylene.

10. A method according to claim 8, wherein the plurality of openings have four sides, wherein a first side and a third side are radiused to match the radius of the container, and the second and fourth sides are parallel to a respective adjacent radial rib.

11. A method according to claim 7, further comprising the steps of:
forming an opening in the central hub; and
forming a thread on an inside of the opening.

12. A method according to claim 11, further comprising the step of affixing a handle to the central hub via the opening.

13. A method according to claim 7, wherein the plurality of openings are tapered.
